(19) United States
(12) Patent Application Publication
(10) Pub. No.: US 2003/0018462 A1
(43) Pub. Date: Jan. 23, 2003

(54) Multi-clock system simulation

(76) Inventors: Liang T. Chen, Saratoga, CA (US); Earl T. Cohen, Fremont, CA (US); Russell Kao, Portola Valley, CA (US); Thomas M. McWilliams, Menlo Park, CA (US)

Correspondence Address: ROSENTHAL & OSHA L.L.P., 1221 MCKINNEY AVENUE, SUITE 2800, HOUSTON, TX, 77010, US

(21) Appl. No.: 10/109,139

(22) Filed: Mar. 28, 2002

Related U.S. Application Data
(60) Provisional application No. 60/305,997, filed on Jul. 16, 2001.

(51) Int. Cl. G06F 17/50

(52) U.S. Cl. 703/19

(57) ABSTRACT

A method and apparatus for simulating a source system having a plurality of source clocks to trigger a plurality of logic elements is provided. The plurality of source clocks are modeled with a global clock. At least one of the plurality of source clocks is modeled with a clock mask and a clock state. At least one of the plurality of logic elements is evaluated when the global clock generates a global clock pulse and updated based on the clock mask and the clock state.

### CROSS-REFERENCE TO RELATED APPLICATIONS

This application claims benefit of U.S. Provisional Application Serial No. 60/305,997, filed Jul. 16, 2001, entitled “Multi-Clock System Simulation,” in the names of Liang T. Chen, Earl T. Cohen, Russell Kao, and Thomas M. McWilliams.

### BACKGROUND OF INVENTION

The invention relates to simulation of digital circuits. In designing digital circuits, it is desirable to achieve high reliability and a balance between production cost and system performance. Designers use various tools such as computer-aided design systems and simulation software to implement, test, and evaluate the architecture of digital circuits. This allows designers to ensure correctness before incurring the time and expense of fabricating a physical prototype.

One use of software simulators is to assist designers in evaluating a given circuit design by varying the parameters (e.g., input signals) of the system. Logic simulation is used to verify the functionality of a digital circuit. Simulation techniques may include event-driven and cycle-based simulation.

Event-driven simulation is used to determine the value or the change in value of a digital circuit's output when an event occurs that affects a digital circuit's input. Within the context of event-driven simulation, an event is defined as an incident that causes the system to change its state in some way. For example, a new event may occur when a digital circuit's input and clock signal change. An event may result in a change in the digital circuit's output value that may in turn create further events.

Event-driven simulation provides a reasonably accurate approximation of a system's behavior, as it closely traces changes in the system at all times. When the architecture includes a multitude of system components, event-driven simulation can become very expensive, because much time and resources need to be dedicated to evaluating and re-evaluating multiple system components at the occurrence of every single event.

Typically, very fast processing units and large memory requirements are necessary to evaluate, track, and record each event. One of the advantages of an event-driven simulation method is that it can be used to verify timing correctness, as well as functional correctness of a digital design. While event-driven simulation provides a detailed and thorough evaluation of a digital circuit, the time and computing resources required may be large.

Cycle-based simulation is applicable to synchronous digital systems and may be used to verify the functional correctness of a digital design. Cycle-based simulators use algorithms that eliminate unnecessary calculations to achieve improved performance in verifying system functionality. Typically, in a cycle-based simulator the entire system is evaluated once at the end of each clock cycle. Therefore, it is not necessary to perform discrete component evaluations and re-evaluations upon the occurrence of every event.

Digital systems typically synchronize their operations to a system clock. FIG. 1 shows a system clock distribution network (100). In this example, system clock (101) is distributed to circuit A (104) via buffers (102a, 102b). Subsequently, it is distributed to circuit B (106) and circuit C (108) via buffers (103a-103n). Circuit A (104) receives a copy of the system clock sooner than circuit B (106) and circuit C (108). Circuit B (106) is triggered by a change in state of the system clock opposite from the change in state of the system clock that triggers circuit C (108). Because circuit A (104), circuit B (106), and circuit C (108) respond at different times or to different states of the system clock, different instantiations of the system clock may be necessary for simulation. All circuits that respond to the same instantiation of the system clock are said to be in the same clock domain.

In FIG. 2A, a block diagram of a multi-clock digital circuit is shown. The digital circuit has clock-triggered flip-flops F1 (201) and F2 (203) and various combinational logic (C/L) elements A (205), B (207), and C (209). A flip-flop is a digital memory device capable of changing (i.e., flip-flopping) between two Boolean values (zeros and ones) based on the value of a data input signal.

Changes at the flip-flop output are synchronized in relation with a specified clock event (e.g., a rising edge). Source clocks C(1) and C(2) are the clock inputs into flip-flops F1 (201) and F2 (203), respectively. Inputs D1 and D2 represent the input signals to flip-flops F1 and F2, respectively.

Digital clocks are used to synchronize the operation of various circuit components by generating sequential digital signals. FIG. 2B illustrates the state diagrams for source clocks C(1) and C(2) used to synchronize the digital circuit of FIG. 2A. Clock pulses are used to synchronize different events and functions within digital circuits.

Logic operations and functions in a synchronized digital circuit are performed in sequential order. Often, one or more clocks are used to synchronize the operation of various digital circuits. When more than one clock is included in a system, each clock can be responsible for synchronizing a separate group of digital circuits. Each group forms a clock domain. Thus, a multi-clock digital circuit can contain multiple clock domains.

Cycle-based simulation of a system with multiple clock domains is more difficult because it requires the evaluation of system components in multiple clock domains at each clock cycle. Because the value of certain components in one domain may be related to the value of a component in another domain, cycle-based analysis of a multi-clock digital system can be very complex. One current method accomplishes this task by partitioning the system into multiple clock domains, analyzing each domain separately, generating a separate execution segment for each domain, and re-analyzing all domains together.

For example, as illustrated in FIGS. 2A and 2B, flip-flop F1 (201) is positively triggered by source clock C(1) and flip-flop F2 (203) is negatively triggered by source clock C(2). Positively triggered flip-flop F1 (201) updates its output q1 value based on input D1 value at instances 1 and 3 when source clock C(1) generates a rising edge caused by a clock state change from low to high. On the other hand, negatively triggered flip-flop F2 (203) is updated at instances 6 and 8 when source clock C(2) generates a falling edge caused by a change from a high clock state to a low clock state.

As illustrated in FIG. 2B, source clocks C(1) and C(2) generate independent pulses. To evaluate the digital circuit illustrated in FIG. 2A, the circuit needs to be divided into two parts, one including flip-flop F1 (201) and C/L element A (205), and the other including flip-flop F2 (203) and C/L element B (207). In one evaluation path, each partition is analyzed independently based on the input and output values at each triggering instance. For example, the partition including flip-flop F1 (201) is evaluated at instances 1 and 3. The output q1 value is set equal to the current value of input D1 at each instance. The current output q1 value is taken into consideration when evaluating combinatorial logic element A for that partition. Similarly, the partition including flip-flop F2 (203) is evaluated at instances 6 and 8, based on input D2 and output q2 values, respectively.

In a second evaluation path, the entire system is analyzed as a whole for all triggering instances in each partition. For example, the evaluation of C/L element C (209), at instances 1, 3, 6, and 8, is based on the value of C/L elements A (205) and B (207) at each of those instances. Thus, a circuit with numerous clock domains is more difficult and costly to simulate than its single domain counterparts. Obviously, the larger the number of domains in a system, the more expensive and time consuming is the simulation of that system.

### SUMMARY OF INVENTION

According to one aspect of the present invention, a method for simulating a source system having a plurality of source clocks to trigger a plurality of logic elements comprises modeling the plurality of source clocks with a global clock, modeling a first one of the plurality of source clocks with a first clock mask and a first clock state, evaluating at least one of the plurality of logic elements when the global clock generates a global clock pulse and updating the at least one of the plurality of logic elements based on the first clock mask and the first clock state.

According to one aspect of the present invention, a computer-readable medium having recorded thereon instructions executable by a processor, the instructions adapted to perform modeling the plurality of source clocks with a global clock, modeling a first one of the plurality of source clocks with a first clock mask and a first clock state, evaluating at least one of the plurality of logic elements when the global clock generates a global clock pulse and updating the at least one of the plurality of logic elements based on the first clock mask and the first clock state.

According to one aspect of the present invention, a system configured to simulate a source system having a plurality of source clocks to trigger a plurality of logic elements, comprises a global clock replacing the plurality of source clocks, and a feedback multiplexer for a memory element of the source system, comprises a feedback wire, and a select signal associated with the plurality of source clocks, where the select signal determines whether an input signal or a feedback signal on the feedback wire is presented to the memory element.

Other aspects and advantages of the invention will be apparent from the following description and the appended claims.

### BRIEF DESCRIPTION OF DRAWINGS

FIG. 1 shows an example of a prior art system clock distribution network to several digital circuits.

FIG. 2A is a block diagram illustrating a prior art multi-clock digital circuit.

FIG. 2B is a state diagram in accordance with the circuit of FIG. 2A.

FIG. 3A is a flow diagram illustrating the manner in which a digital circuit with multiple clock domains may be simulated using one global clock, according to an embodiment of the invention.

FIG. 3B is a state diagram in accordance with an embodiment of the present invention.

FIG. 4 is a block diagram illustrating a multi-clock digital circuit simulated using a global clock according to an embodiment of the present invention.

FIG. 5 illustrates a table of values associated with various states for source clocks C(1) and C(2), according to an embodiment of the invention.

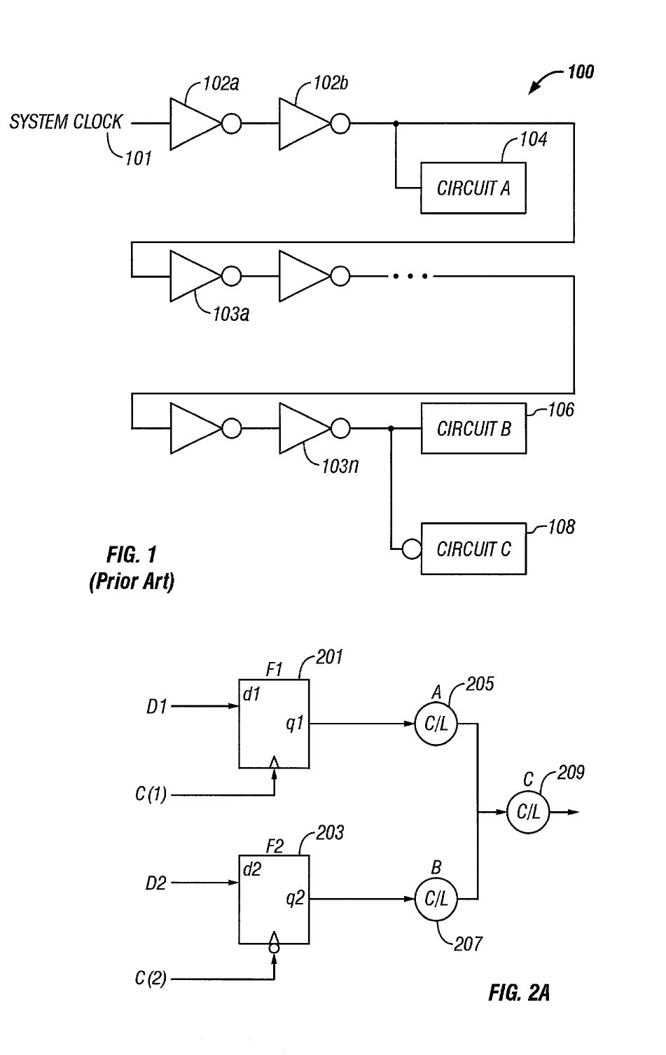

### DETAILED DESCRIPTION

A method and apparatus for simulating a source system having multiple source clocks to trigger multiple logic elements is described. In the following description, numerous specific details are set forth in order to provide a more thorough understanding of the present invention. It will be apparent, however, to one skilled in the art that the present invention may be practiced without these specific details. Further, this invention in one or more embodiments may be implemented in the form of hardware and/or software.

The invention may be used to simulate an electronic system by transforming a multi-clock digital system (i.e., multiple source clock system) into a single clock digital system (i.e., global clock system). This allows for an efficient and complete sequential simulation of the source circuit without the need to partition the source circuits into multiple clock domains.

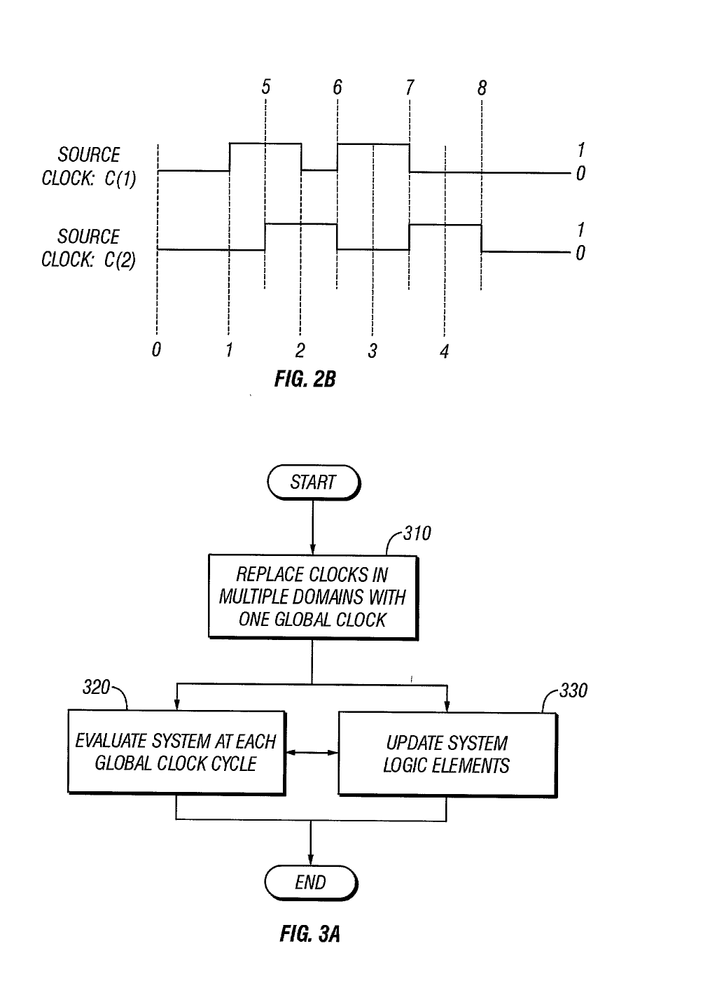

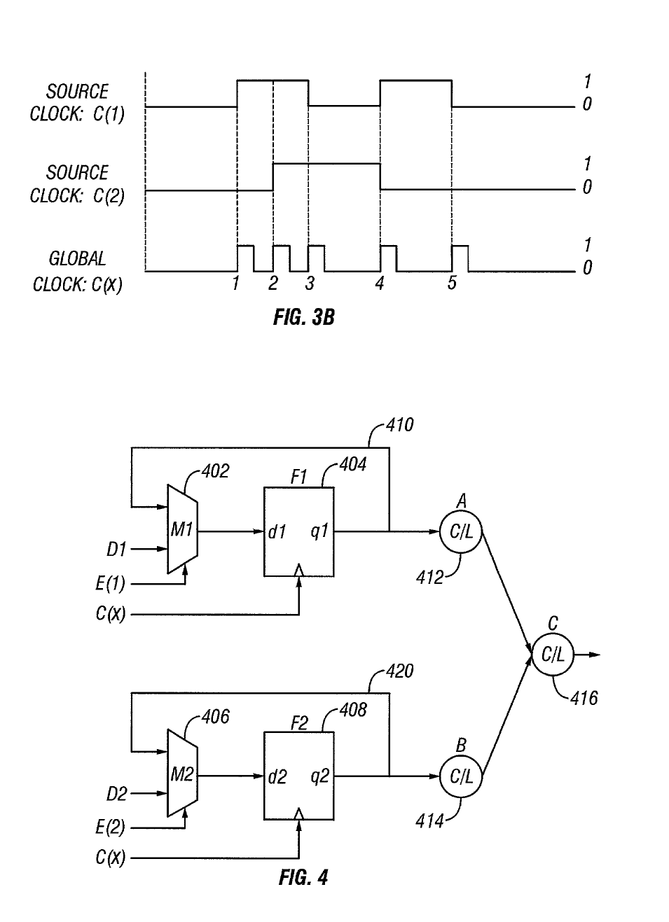

FIG. 3A shows a flow diagram illustrating the manner in which a digital circuit with multiple clock domains may be simulated using one global clock. For the purpose of illustration, consider the multi-clock digital circuit of FIG. 2A having inputs D1 and D2. FIG. 2A includes two clock domains including logic elements, such as flip-flops F1 (201) and F2 (203), that are respectively synchronized by source clocks C(1) and C(2). The value of system components, including the flip-flops F1 (201) and F2 (203), and C/L elements A (205), B (207), and C (209) are dependent upon changes in the values of inputs D1 and D2 as well as changes in the state of source clocks C(1) and/or C(2).

Flip-flop F1 (201) generates an output q1. When flip-flop F1 (201) is triggered, the value of output q1 is set equal to input D1. For example, if source clock C(1) generates a rising edge, then the value of output q1 is updated to reflect the value of input D1, at that point in time. Until the next clock cycle (i.e., the next time source clock C(1) generates a rising edge), the value of output q1 remains unchanged, even if the value of input D1 is altered in the interim. Flip-flop F2 (203) works in the same manner, with the exception that it is negatively triggered, meaning that output q2 assumes the value of input D2 at a falling edge of source clock C(2).

In a cycle-based simulation, a digital circuit is evaluated at the end of each clock cycle regardless of any events that may have occurred within that cycle. A clock cycle refers to the period between one clock signal and the next. Referring to FIG. 2B, the state diagram of source clock C(1) enclosed between vertical lines 1 and 3, represents a clock cycle for source clock C(1). Thus, referring to FIG. 2A, in a cycle-based simulation, C/L elements A (205), B (207), and C (209) are evaluated based on the values generated by flip-flops F1 (201) and F2 (203) at the end of each clock cycle.

To simulate the multi-clock digital circuit of FIG. 2A into a single-clock digital circuit having one domain, at (310), all clocks of the source system (e.g., source clocks C(1) and C(2)) are replaced by a single global clock C(x). FIG. 3B illustrates a state diagram of source clocks C(1) and C(2) and global clock C(x), according to an embodiment of the invention. In order for the system to be evaluated in a single path, rather than multiple evaluation paths, global clock C(x) is implemented so that it generates a triggering pulse for all sequential logic elements in the circuit, during each cycle, as further explained below. A global clock cycle is initiated each time global clock C(x) generates a rising edge or pulse. A rising edge is denoted by a transition from a low clock state (zero) to a high clock state (one) as illustrated in FIG. 3B, instances 1 through 5 of global clock C(x).

At (320), all elements of the simulated system are evaluated at each global clock cycle. In one or more embodiments of the invention, global clock C(x) is implemented so that it generates a rising edge when at least one of the source clocks C(1) or C(2) produces a rising or a falling edge. This implementation in conjunction with a method (further described below) is used to trigger system components as if the system is triggered by multiple clocks.

For example, as illustrated in FIG. 3B, at instances 1 and 2, global clock C(x) produces a rising edge when in the source system, source clock C(1) (at instance 1) produces a rising edge, and source clock C(2) (at instance 2) produces a rising edge. At instances 3 and 5, global clock C(x) produces a rising edge when in the source clock C(1) produces a falling edge at each instance. At instance 4, global clock C(x) produces a rising edge when in the source clock C(1) produces a rising edge and source clock C(2) produces a falling edge. Embodiments of the invention may be also implemented so that the circuit components may be triggered on the falling edge of the global clock C(x).

In one or more embodiments of the invention, once global clock C(x) generates a triggering pulse to simulate a change in state on source clocks C(1) and C(2), a simulation algorithm is used to trigger the system's components as they are triggered in the source system. This algorithm, as further described below, at (330) causes the system's C/L elements to be updated based on changes in the state in the source clocks. This change in state occurs when source clock C(1) generates a rising edge, and/or when source clock C(2) generates a falling edge, for example. Various methods can be implemented to simulate a source clock that generates a rising or a falling edge.

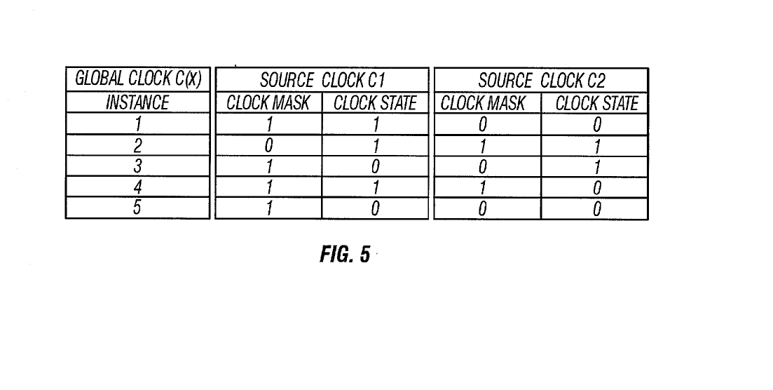

Two attributes are associated with each source clock: a clock mask and a clock state. Clock mask has a binary value of one every time a source clock generates a rising or a falling edge. For example, as illustrated in FIG. 3B and FIG. 5, clock mask for source clock C(1) at instances 1, 3, 4, and 5 is one. The clock mask for source clock C(1) has a binary value of zero at instance 2 because source clock C(1) does not generate an edge at that instance. Clock state, on the other hand, has a binary value of one when a source clock generates a high signal, and a binary value of zero when the source clock generates a low signal. For example, clock state for source C(1) at instances 1, 2, and 4 is one (high signal); and clock state at instances 3 and 5 is zero (low signal). FIG. 5, Table 1 and Table 2 below summarize the clock mask and clock state values for source clocks C(1) and C(2), at instances 1 through 5.

| Global | Table 1 | | Table 2 | |
|---|---|---|---|---|
| Clock C(x) | Source Clock C(1) | | Source Clock C(2) | |
| Instance | Clock Mask | Clock State | Clock Mask | Clock State |
| 1 | 1 | 1 | 0 | 0 |
| 2 | 0 | 1 | 1 | 1 |
| 3 | 1 | 0 | 0 | 1 |
| 4 | 1 | 1 | 1 | 0 |
| 5 | 1 | 0 | 0 | 0 |

Using the above tables, rising or falling clock edges may be easily simulated for source clocks C(1) and C(2). For example, a rising edge for instances 1 and 4 can be simulated for C(1) when both clock mask and clock state form a set of particular binary values, for example both one. A clock mask binary value of one denotes the generation of an edge, and a clock state of one denotes a possible state change from low to high (i.e., zero to one), thus indicating a rising edge. By the same token, a falling edge for instance 4 may be simulated for source C(2) when both clock mask and clock state form a set of particular binary values, for example when clock mask is one and clock state is zero.

In one or more embodiments of the invention, the above simulation scheme is used to generate digital circuit binary values as if the system was a multi-clock digital circuit. Thus, at instances 1 and 4 when source clock C(1) produces a rising edge, logic elements that were in the clock domain triggered by source clock C(1) are updated based on the binary value of input D1. Similarly, at instance 4 when source clock C(2) produces a falling edge, logic elements that were in the clock domain triggered by source clock C(2) are updated based on the binary value of input D2.

At (330), the binary value for output q1 is updated at instances 1, 4, and any other instances when source clock C(1) has a clock mask and clock state binary value of one. Likewise, the binary value for output q2 is updated at instance 4 and any other instance when source clock C(2) has a clock mask of one and a clock state of zero. At all other instances, the binary values of input D1 and D2 and the binary values of outputs q1 and q2 remain unchanged. The described logical relationship between the binary values of the inputs (e.g., D1, D2, etc.), outputs (e.g., q1, q2, etc.), clock mask, and clock state for source clocks C(1) and C(2) in a simulated system can be described in the algorithm listed below:

@global clock

if clock mask(C(1)) && clock_state(C(1))

q1=d1

if clock_mask(C(2)) && NOT(clock_state(C(2)))

q2=d2

Using the above tables, a sequential executable code may be implemented to simulate the multi-clock digital circuit of FIG. 2A as a single domain digital circuit. The multi-clock digital circuit of FIG. 2A is for illustration purposes only. The same concept can be applied to any sequential circuit that includes multiple clock domains.

One or more embodiments of the invention may be implemented as hardware in the form of an electronic circuit. In this form, the transformation of a multi-clock digital system into a single clock digital system is accomplished, for example, by adding a feedback multiplexer to each memory component (e.g., flip-flop). A multiplexer is a digital device that selects one or more signals as an output chosen from multiple input signals, based on one or more select signal's binary value.

In one or more embodiments of the invention, input signals for each clock domain are input to the added multiplexers. The select signal's binary value for each added multiplexer is calculated based on signals generated by the associated source clock. While logic elements of each domain are evaluated at each global clock cycle, any change in their binary value remains a function of the source clock for that domain.

For the purpose of illustration, consider the multi-clock digital circuit of FIG. 2A, having inputs D1 and D2. It includes two clock domains including sequential logic elements, such as flip-flops F1 (201) and F2 (203), that are synchronized by source clocks C(1) and C(2). Using one or more embodiments of the invention, the multi-clock digital circuit of FIG. 2A may be transformed into a single clock digital circuit. FIG. 4 shows a block diagram illustrating the various components of a multi-clock digital circuit, simulated using a global clock digital circuit. Multiplexers M1 (402) and M2 (406) are two-to-one multiplexers (i.e., multiplexers with two inputs and one output) having select signals E(1) and E(2), respectively. Input D1 is input into multiplexer M1 (402) and input D2 is input into multiplexer M2 (406). Multiplexers M1 (402) and M2 (406) select from respective input signals D1 and D2 based on select signals E(1) and E(2). The multiplexer M1 (402) output is presented to flip-flop F1 (404) and multiplexer M2 (406) output is presented to flip-flop F2 (408). Flip-flops F1 (404) and F2 (408) are synchronized by global clock C(x). Flip-flops F1 (404) and F2 (408) are loaded with the binary value presented from the output of the multiplexer M1 (402) and M2 (406), respectively, on a rising edge of C(x). Flip-flops F1 (404) and F2 (408) outputs are input into the C/L elements A (412), B (414), and C (416). Wires (410) and (420) feedback the flip-flop F1 (404) and F2 (408) outputs to multiplexers M1 (402) and M2 (406), respectively.

Still referring to FIG. 4, global clock C(x) generates a rising edge every time C(1) or C(2) generates a rising or a falling edge as previous shown in FIG. 3B. Each multiplexer M1 (402) and M2 (406) selects from two input signals. One input signal is provided by feedback wires (410) or (420), the other is provided by inputs D1 or D2. When select signal E(1) for multiplexer M1 (402) is high, input D1 is produced as the output, otherwise the signal provided by wire (410) is produced as the output. Similarly, multiplexer M2 (406) produces D2 if E(2) is high; otherwise, multiplexer M2 (406) outputs the signal produced by wire (420). The routing of the output generated by flip-flops F1 (404) and F2 (408) through wires (410) and (420) provides for a constant output binary value generated by flip-flops F1 (404) and F2 (408) when the binary values of select signals E(1) or E(2) are low. The output generated by flip-flops F1 (404) or F2 (408) remains unchanged until select signals E(1) or E(2) cause inputs D1 or D2 to be selected as output.

In one or more embodiments of the invention, the binary value of select signals E(1) and E(2) is determined such that output signals generated by multiplexers M1 (402) and M2 (406) are selected from input signals D1 or D2 when the source clocks C(1) and C(2) generate a rising or a falling edge. The select signals generated by source clocks C(1) and C(2) can depend on whether the flip-flop associated with the clock is positively or negatively triggered. For example, in FIG. 2A, flip-flop F1 (201) is positively triggered and flip-flop F2 (203) is negatively triggered. To properly simulate the circuit of FIG. 4, using a common clock C(x), select signal E(1) is set when source clock C(1) generates a rising edge; and select signal E(2) is set when source clock C(2) generates a falling edge.

Various methods can be used to simulate a triggering clock that generates a rising or a falling edge. Using tables 1 and 2 to simulate clock state and clock mask binary values for each clock, it can be easily determined when a source clock C(1) or C(2) produces a rising or a falling edge. For example, referring to FIG. 5, source clock C(1) produces a rising edge at instances 1 and 4 when both clock mask and clock state are one. Source clock C(2) produces a falling edge at instance 4 when clock mask is one and clock state is zero.

The invention may be implemented so that select signal E(1) is set at instances 1 and 4 when C(1) produces a rising edge. Similarly, select signal E(2) is set at instance 4, when C(2) produces a falling edge. Consequently, input signal D1 is selected by multiplexer M1 (402) at instances 1, 4, and any other instance when C(1) has a clock mask and clock state binary value of one. Input signal D2 is selected by multiplexer M2 (406) at instance 4 and any other instance when C(2) has a clock mask of one and a clock state of zero. The concept illustrated in FIG. 4 can be applied to any multi-clock circuit.

Those skilled in the art will appreciate that the specific binary values used in this description are for illustrative purposes. Alternate binary representations, so long as they provide similar functionality, are equally possible.

Those skilled in the art will appreciate that a wide variety of digital circuitry may benefit from this invention. The digital circuitry may include various arrangements of state storage elements such as flip-flops and latches, and any arrangement of a multi-clock system that includes, but is not limited to, different clocks, temporally shifted clocks, different frequency clocks, and different edge triggered clocks.

Those skilled in the art will appreciate that the transformation of a multi-clock digital circuit into a single clock digital circuit is advantageous and its benefits may be exploited by a variety of simulation programs.

Advantages of the present invention include one or more of the following. The invention provides the advantages of software simulation of a multi-clock digital system as a single clock domain. A single clock domain is less difficult and less costly to simulate than a multi-clock domain. Also, the clock mask may be used directly to eliminate any further clock logic evaluation; therefore, instruction execution and logic evaluation costs are reduced. This invention further provides a hardware implementation to provide a single clock digital system from a multi-clock digital system.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for simulating a source system having a plurality of source clocks to trigger a plurality of logic elements, comprising:
modeling the plurality of source clocks with a global clock;
modeling a first one of the plurality of source clocks with a first clock mask and a first clock state; and
evaluating at least one of the plurality of logic elements when the global clock generates a global clock pulse and updating the at least one of the plurality of logic elements based on the first clock mask and the first clock state.

2. The method of claim 1, further comprising:
modeling a second one of the plurality of source clocks with a second clock mask and a second clock state.

3. The method of claim 1, wherein the global clock generates the global clock pulse when at least one of the plurality of source clocks generates a source clock rising edge and when at least one of the plurality of source clocks generates a source clock falling edge.

4. The method of claim 1, wherein the first clock mask has a first binary value when the at least one of the plurality of source clocks generates a source clock rising edge and when the at least one of the plurality of source clocks generates a source clock falling edge.

5. The method of claim 1, wherein the clock state has a second binary value when the at least one of the plurality of source clocks is at a desired level.

6. The method of claim 1, wherein the at least one of the plurality of logic elements is updated when at least one of the plurality of source clocks generates a source clock edge.

7. The method of claim 1, wherein at least one of the plurality of logic elements is a positively triggered logic element, and wherein the at least one positively triggered logic element is updated when at least one of the plurality of source clocks generates a rising source clock edge.

8. The method of claim 1, wherein at least one of the plurality of logic elements is a negatively triggered logic element, and wherein the at least one negatively triggered logic element is updated when at least one of the plurality of source clocks generates a falling source clock edge.

9. A computer-readable medium having recorded thereon instructions executable by a processor, the instructions adapted to perform:
modeling the plurality of source clocks with a global clock;
modeling a first one of the plurality of source clocks with a first clock mask and a first clock state; and
evaluating at least one of the plurality of logic elements when the global clock generates a global clock pulse and updating the at least one of the plurality of logic elements based on the first clock mask and the first clock state.

10. The computer-readable medium of claim 9, further comprising:
modeling a second one of the plurality of source clocks with a second clock mask and a second clock state.

11. The computer-readable medium of claim 9, wherein the global clock generates the global clock pulse when at least one of the plurality of source clocks generates a source clock rising edge and when at least one of the plurality of source clocks generates a source clock falling edge.

12. The computer-readable medium of claim 9, wherein the first clock mask has a first binary value when the at least one of the plurality of source clocks generates a source clock rising edge and when the at least one of the plurality of source clocks generates a source clock falling edge.

13. The computer-readable medium of claim 9, wherein the clock state has a second binary value when the at least one of the plurality of source clocks is at a desired level.

14. The computer-readable medium of claim 9, wherein the at least one of the plurality of logic elements is updated when at least one of the plurality of source clocks generates a source clock edge.

15. The computer-readable medium of claim 9, wherein at least one of the plurality of logic elements is a positively triggered logic element, and wherein the at least one positively triggered logic element is updated when at least one of the plurality of source clocks generates a rising source clock edge.

16. The computer-readable medium of claim 9, wherein at least one of the plurality of logic elements is a negatively triggered logic element, and wherein the at least one negatively triggered logic element is updated when at least one of the plurality of source clocks generates a falling source clock edge.

17. A system configured to simulate a source system having a plurality of source clocks to trigger a plurality of logic elements, comprising:
a global clock replacing the plurality of source clocks; and
a feedback multiplexer for a memory element of the source system, comprising:
a feedback wire, and
a select signal associated with the plurality of source clocks, wherein the select signal determines whether an input signal or a feedback signal on the feedback wire is presented to the memory element.

18. The system of claim 17, wherein the global clock generates a global clock pulse when at least one of the plurality of source clocks generates a source clock rising edge and when at least one of the plurality of source clocks generates a source clock falling edge.

19. The system of claim 17, wherein the select signal causes the memory element to be loaded with the input signal when at least one of the plurality of source clocks generates a source clock edge.

20. The system of claim 17, wherein the memory element is a positively triggered memory element, and wherein the select signal causes the positively triggered memory element to be loaded with the input signal when at least one of the plurality of source clocks generates a rising source clock edge.

21. The system of claim 17, wherein the memory element is a negatively triggered memory element, and wherein the select signal causes the negatively triggered memory element to be loaded with the input signal when at least one of the plurality of source clocks generates a falling source clock edge.

22. The system of claim 17, wherein the memory element is a positively triggered memory element, and wherein the select signal causes the positively triggered memory element to be loaded with the feedback signal on the feedback wire when at least one of the plurality of source clocks is not generating a rising source clock edge.

23. The system of claim 17, wherein the memory element is a negatively triggered memory element, and wherein the select signal causes the negatively triggered memory element to be loaded with the feedback signal on the feedback wire when at least one of the plurality of source clocks is not generating a falling source clock edge.

24. A method for simulating a source system having a plurality of source clocks to trigger a plurality of logic elements, comprising:
means for modeling the plurality of source clocks with a global clock;
means for modeling a first one of the plurality of source clocks with a first clock mask and a first clock state; and
means for evaluating at least one of the plurality of logic elements when the global clock generates a global clock pulse and updating the at least one of the plurality of logic elements based on the first clock mask and the first clock state.
